(19) United States
(12) Patent Application Publication
(10) Pub. No.: US 2025/0392662 A1
(43) Pub. Date: Dec. 25, 2025

(54) ELECTRONIC DEVICE HOLDER

(71) Applicant: Shenzhen Qianhai Lamiku Information Technology Co., LTD, Shenzhen (CN)

(72) Inventors: Bo ZHANG, Shenzhen (CN); Tianhui ZHOU, Shenzhen (CN); Lianzeng LI, Shenzhen (CN)

(73) Assignee: Shenzhen Qianhai Lamiku Information Technology Co., LTD, Shenzhen (CN)

(21) Appl. No.: 19/243,478

(22) Filed: Jun. 19, 2025

(30) Foreign Application Priority Data
Jun. 24, 2024 (CN) 202421450979.8

(51) Int. Cl. H04M 1/04

(52) U.S. Cl. CPC H04M 1/04

(57) ABSTRACT

The present application provides an electronic device holder, including a base, a first connecting member, a second connecting member and a supporting member; the first connecting member is rotatable relative to the base, one end of the supporting member is rotatably connected to the first connecting member, and an other end of the supporting member is rotatably connected to the second connecting member. The electronic device holder provided by the present application has the advantages of being capable of rotating relative to the electronic device at will when a vertical screen mode and a horizontal screen mode are used, and the placing angle of the electronic device can be adjusted.

### CROSS-REFERENCE TO RELATED APPLICATION

Pursuant to 35 U.S.C. § 119 and the Paris Convention Treaty, the present application claims the benefit of Chinese Patent Application No. 202421450979.8 filed Jun. 24, 2024, the contents of which are incorporated herein by reference.

### TECHNICAL FIELD

The present application relates to the technical field of electronic product holder, and more specifically to an electronic device holder.

### BACKGROUND

In today's society, people often spend long hours looking at their phones, since there is no support object and the mobile phone needs to hold in the hand, or the mobile phone is placed on the table and look down with the head down, the arm, shoulder and cervical vertebra are prone to be harmed after a long time.

The patent application CN308090358S disclosed a foldable phone holder (FY-010 series, which includes two rings and a supporting rod arranged between the two rings, and the two rings are rotatably connected to the two ends of the supporting rod, but after the support structure is connected with the mobile phone, the rings connected with the mobile phone cannot rotate relative to the back of the mobile phone, or the rings connected with the mobile phone directly rotates relative to the back of the mobile phone, thereby causing abrasion of the back of the mobile phone or the mobile phone shell, and in addition, the support cannot adjust the relative angle of the mobile phone when supporting the mobile phone in a vertical screen or a horizontal screen state.

### SUMMARY

The present application provides an electronic device holder for solving the problem that the existing mobile phone holder cannot adjust the angle when being used in a vertical screen mode and a horizontal screen mode.

The electronic device holder provided according to embodiments of the present application includes a base, a first connecting member, a second connecting member, and a supporting member; the first connecting member is rotatable relative to the base, one end of the supporting member is rotatably connected to the first connecting member, and an other end of the supporting member is rotatably connected to the second connecting member.

Preferably, the base, the first connecting member, and the second connecting member are annular structures, and the second connecting member is configured for a finger to pass through.

Preferably, the base is provided with a receiving groove, and the first connecting member is received in the receiving groove.

Preferably, the base includes a shell and a thimble, the thimble is elastically connected to the shell, an edge of the first connecting member that is rotatable relative to the base is provided with a first tooth, and the thimble is elastically matched with the first tooth.

Preferably, the shell is further provided with a magnetic member, and the magnetic member is arranged in an array in the shell.

Preferably, a first rotating shaft is arranged between the first connecting member and the supporting member, and a second rotating shaft is arranged between the second connecting member and the supporting member, the first rotating shaft is configured to realize rotating between one end of the supporting member and the first connecting member, and the second rotating shaft is configured to realize rotating between an other end of the supporting member and the second connecting member.

Preferably, both sides of each of the first rotating shaft and the second rotating shaft are provided with a second tooth.

Preferably, an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

The technical scheme provided by the embodiments of the present application can have the following beneficial effects:

The present application provides an electronic device holder, which includes the base, the first connecting member, the second connecting member, and the supporting member. The first connecting member rotates relative to the base, and one end of the supporting member is rotatably connected to the first connecting member, while the other end of the supporting member is rotatably connected to the second connecting member. By rotating the first connecting member relative to the base, the electronic device holder can freely rotate relative to the electronic device during vertical and horizontal screen use, so as to adjust the placement angle of the electronic device.

### BRIEF DESCRIPTION OF THE DRAWINGS

In order to more clearly illustrate the technical scheme of the embodiments of the present application, the following will briefly introduce the drawings needed to be used in the embodiment description, obviously, the drawings in the following description are some embodiments of the present application, and for those skilled in the art, other drawings can also be obtained according to these drawings without paying creative labor.

FIG. 1 is a perspective view of an electronic device holder in a folded state;

FIG. 2 is a perspective view of an electronic device holder in an unfolded state;

FIG. 3 is an exploded structural schematic view of an electronic device holder;

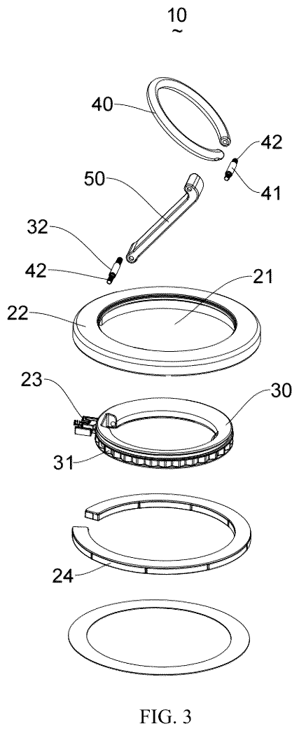

FIG. 4 is a perspective view of an electronic device holder in another unfolded state;

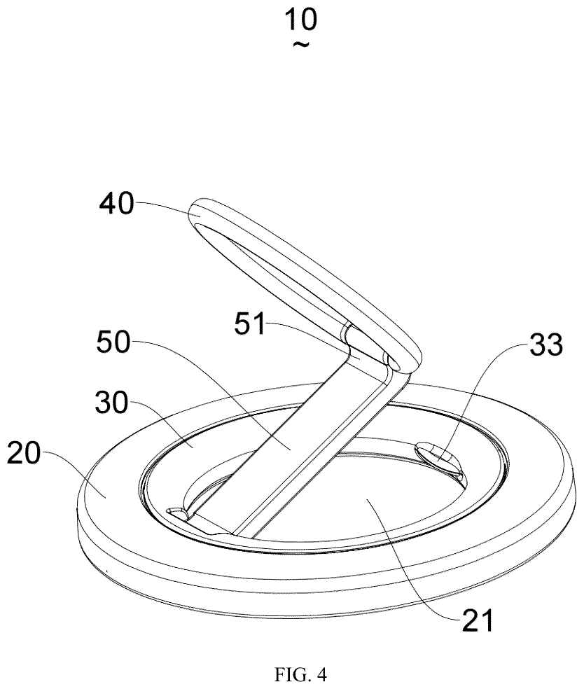

FIG. 5 is a use state schematic view of the electronic device holder.

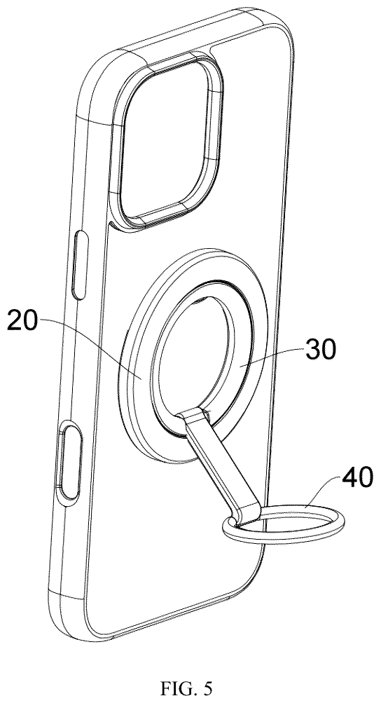

In the drawings, reference numerals are listed as following:

10—electronic device holder; 20—base; 21—receiving groove; 22—shell; 23—thimble; 24—magnetic member; 30—first connecting member; 31—first tooth; 32—first rotating shaft; 33—protrusion; 40—second connecting member; 41—second rotating shaft; 42—second tooth; 50—supporting member; and 51—abutting member.

### DETAILED DESCRIPTION

The technical scheme in the embodiments of the present application will be described clearly and completely below in conjunction with the drawings in the embodiments of the present application. Obviously, the described embodiments are some of the embodiments of the present application, rather than all the embodiments. Based on the embodiments of the present application, all other embodiments obtained by those skilled in the art without creative labor are within the protection scope of the present application.

It is also to be understood that the terminology used herein is for the purpose of describing particular embodiments of the present application only and is not intended to limit the present application. As used in this specification and the appended claims, the singular forms “a,” “an” and “the” are intended to include the plural forms as well, unless the context clearly indicates otherwise.

It should also be further understood that the term “and/or” as used in the specification and the appended claims, means any one of the associated listed items, as well as any combination and all possible combinations of the associated listed items.

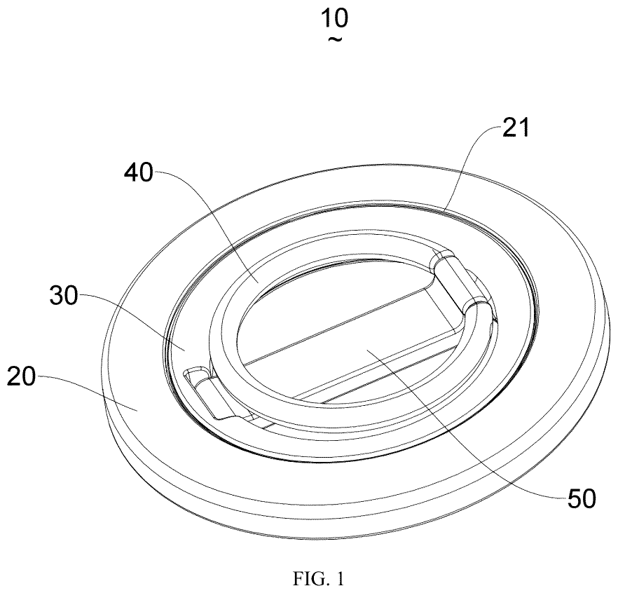

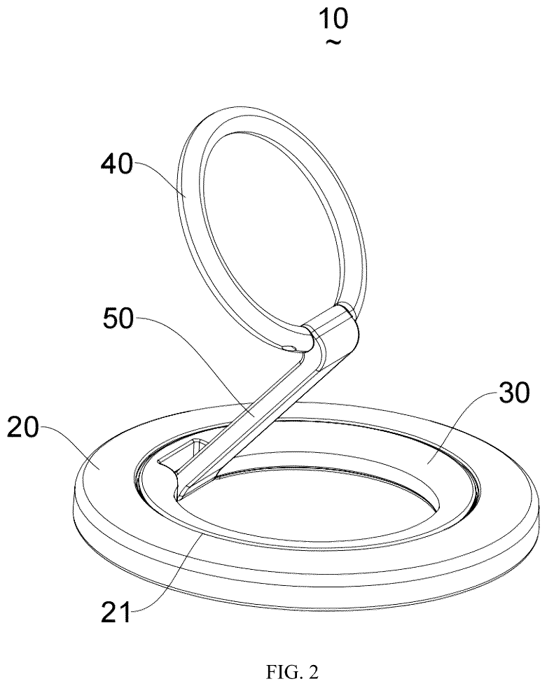

As shown in FIGS. 1 to 2, the present application provides an electronic device holder 10, which includes a base 20, a first connecting member 30, a second connecting member 40 and supporting member 50; the first connecting member 30 is rotatable relative to the base 20, one end of the supporting member 50 is rotatably connected with first connecting member 30, the other end of the supporting member 50 is rotatably connected with the second connecting member 40.

In the embodiment, the base 20, the first connecting member 30 and the second connecting member 40 are annular structures. The second connecting member 40 is provided for a user to pass a finger through or being placed and fixed on a horizontal plane. The base 20 is provided with a receiving groove 21, and the first connecting member 30 is received in the receiving groove 21.

The base 20 includes a shell 22 and a thimble 23, the thimble 23 is elastically connected with the shell 22, the first connecting member 30 is provided with a first tooth 31 at an edge of the first connecting member 30 relative to the base 20, and the thimble 23 is elastically matched with the first tooth 31. With the design, when the base 20 and the first connecting member 30 are relatively rotated, a crisp “click” sound can be generated, and meanwhile, during the relative rotation process between the base 20 and the first connecting member 30, there is a layered damping feedback, which enhances the user experience.

The shell 22 is further provided with a magnetic member 24, and the magnetic member 24 is arranged in an annular array in the shell 22. With the design of the magnetic member 24, the electronic device holder 10 is convenient to be magnetically connected with electronic devices such as mobile phones and tablets.

The first rotating shaft 32 is arranged between the first connecting member 30 and the supporting member 50, and the second rotating shaft 41 is arranged between the second connecting member 40 and the supporting member 50; the rotation between one end of the supporting member 50 and the first connecting member 30 is realized through the first rotating shaft 32, and the rotation between the other end of the supporting member 50 and the second connecting member 40 is realized through the second rotating shaft 41. In the embodiment, both sides of the supporting member 50 are provided with through holes, and the first rotating shaft 32 and the second rotating shaft 3 are arranged passing through the through holes.

Both sides of each of the first rotating shaft 32 and the second rotating shaft 41 are provided with a second teeth 42. The second teeth 42 are adopted to prevent the first rotating shaft 32 and the second rotating shaft 41 from loosening.

The inner side of the first connecting member 30 is provided with a protrusion 33, the supporting member 50 is provided with a abutting member 51, the abutting member 51 is in an arc shape, the abutting member 51 can be abutted against the protrusion 33, and the abutting member 51 is rotatably connected with the second connecting member 40. When the second connecting member 40 and the supporting member 50 are folded and stored in the receiving groove 21, the abutting member 51 is abutted against the protrusion 33, and the abutting member 51 is engaged with the protrusion 33, and the second connecting member 40 and the supporting member 50 can be folded and fixed in the receiving groove 21.

In applications, the electronic device holder 10 is magnetically connected or bonded with a mobile phone or a mobile phone shell, the first connecting member 30 is rotated relative to the base 20, one end of the supporting member 50 is rotatably connected with the first connecting member 30, and the other end of the supporting member 50 is rotatably connected with the second connecting member 40, the angle can be adjusted according to a use scene, the mobile phone can be placed on a horizontal plane such as a desktop in a vertical screen or a horizontal screen mode, meanwhile, the second connecting member 40 is convenient for fingers to pass through, and the fingers are convenient to adjusting the angle of the electronic device by controlling the electronic device holder 10.

The technical scheme provided by the embodiment of the present application can have the following beneficial effects:

The present application provides an electronic device holder, which includes the base, the first connecting member, the second connecting member, and the supporting member. The first connecting member rotates relative to the base, and one end of the supporting member is rotatably connected to the first connecting member, while the other end of the supporting member is rotatably connected to the second connecting member. By rotating the first connecting member relative to the base, the electronic device holder can freely rotate relative to the electronic device during vertical and horizontal screen use, so as to adjust the placement angle of the electronic device.

The above is only a specific embodiment of the present application, but the protection scope of the present application is not limited to this, and those skilled in the art can easily think of various equivalent modifications or replacements within the technical scope disclosed by the present application, and these modifications or replacements should be covered in the protection scope of the present application. Therefore, the protection scope of the present application should be the protection scope of the claims.

What is claimed is:

1. An electronic device holder, comprising:
a base,
a first connecting member,
a second connecting member, and
a supporting member;
wherein the first connecting member is rotatable relative to the base, one end of the supporting member is rotatably connected to the first connecting member, and an other end of the supporting member is rotatably connected to the second connecting member.

2. The electronic device holder according to claim 1, wherein the base, the first connecting member, and the second connecting member are annular structures, and the second connecting member is configured for a finger to pass through.

3. The electronic device holder according to claim 1, wherein the base is provided with a receiving groove, and the first connecting member is received in the receiving groove.

4. The electronic device holder according to claim 3, wherein the base comprises a shell and a thimble, the thimble is elastically connected to the shell, an edge of the first connecting member that is rotatable relative to the base is provided with a first tooth, and the thimble is elastically matched with the first tooth.

5. The electronic device holder according to claim 4, wherein the shell is further provided with a magnetic member, and the magnetic member is arranged in an array in the shell.

6. The electronic device holder according to claim 1, wherein a first rotating shaft is arranged between the first connecting member and the supporting member, and a second rotating shaft is arranged between the second connecting member and the supporting member, the first rotating shaft is configured to realize rotating between one end of the supporting member and the first connecting member, and the second rotating shaft is configured to realize rotating between an other end of the supporting member and the second connecting member.

7. The electronic device holder according to claim 6, wherein both sides of each of the first rotating shaft and the second rotating shaft are provided with a second tooth.

8. The electronic device holder according to claim 1, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

9. The electronic device holder according to claim 2, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

10. The electronic device holder according to claim 3, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

11. The electronic device holder according to claim 4, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

12. The electronic device holder according to claim 5, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

13. The electronic device holder according to claim 6, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.

14. The electronic device holder according to claim 7, wherein an inner side of the first connecting member is provided with a protrusion, the supporting member is provided with an abutting member, the abutting member is in an arc shape, the abutting member is capable of being abutted against the protrusion, and the abutting member is rotatably connected to the second connecting member.
